(19) United States
(12) Patent Application Publication
(10) Pub. No.: US 2014/0338323 A1
(43) Pub. Date: Nov. 20, 2014

(54) PERCHING MECHNISM EMPLOYING SHAPE-MEMORY EFFECT

(71) Applicants: Amirpasha Peyvandi, Lansing, MI (US); Parviz Soroushian, Okemos, MI (US); Jue Lu, Okemos, MI (US)

(72) Inventors: Amirpasha Peyvandi, Lansing, MI (US); Parviz Soroushian, Okemos, MI (US); Jue Lu, Okemos, MI (US)

(73) Assignee: METNA CO., Lansing, MI (US)

(21) Appl. No.: 13/855,777

(22) Filed: Apr. 3, 2013

(51) Int. Cl. F03G 7/06

(52) U.S. Cl. CPC F03G 7/065
USPC 60/527

(57) ABSTRACT

A perching mechanism is developed which comprises shape-memory components capable of undergoing motions that render the perching effect. This mechanism can provide unmanned air vehicles with versatile, bird-like landing capabilities on surfaces of different types and orientations.

### STATEMENT REGARDING FEDERALLY SPONSORED RESEARCH OR DEVELOPMENT

The present invention was supported in part by the U.S. Air Force under Contract Number FA 8651-07-C-0092. The U.S. Government may have certain rights in the invention.

### CROSS-REFERENCE TO RELATED APPLICATIONS

Not applicable.

### BACKGROUND OF THE INVENTION

The following is a tabulation of some prior art that presently appears relevant:

| Pat. No. | Kind Code | Issue Date | Patentee |
|---|---|---|---|
| 2008/0164,080 | A1 | July 2008 | Asbeck et al. |
| 7,658,347 | B2 | February 2010 | Goossen et al. |

### Nonpatent Literature Documents

Cory, R. and R. Tedrake (2008). “Experiments in fixed-wing uav perching.” AIAA Guidance, Navigation and Control Conference.
Frank, A., J. S. McGrew, et al. (2007). “Hover, transition, and level flight control design for a single-propeller indoor airplane.” AIAA Guidance, Navigation and Control Conference.
Kovac, M., J. Germann, et al. (2009). “A perching mechanism for micro aerial vehicles.” J. Micro-Nano Mech 5: 77-91.
Lussier, D. and M. R. Cutkosky (2010). “Landing and perching on vertical surfaces with microspines for small unmanned air vehicles.” J intell Robot Syst 57: 313-327.
Wickenheiser, A. and E. Garcia (2006). “Longitudinal dynamics of a perching aircraft.” J. Aircr. 43: 1386-1392.
Wickenheiser, A. and E. Garcia (2007). “Perching aerodynamics and trajectory optimization.” SPIE.
Wickenheiser, A. and E. Garcia (2008). “Optimization of perching maneuvers through vehicle morphing.” J. Guid 31: 815-823.

### FIELD OF INVENTION

The present invention relates to a mechanism which enables reliable and versatile adherence during locomotion on diverse surfaces irrespective of their type, roughness and curvature via a perching action.

### BACKGROUND OF INVENTION

Miniature, bird-like unmanned air vehicles (Micro Air Vehicles-MAVs) would be greater value if they provide more versatile air and ground mobility. This invention relates to improvement of the ground mobility of Micro Air Vehicles.

Micro air vehicles should preferably be capable of landing and locomotion on surfaces of different types, inclinations, roughnesses, curvatures, and moisture conditions. A bird-like perching action, complemented with reversible action, can provide viable means of landing on and locomotion against surfaces of diverse types and conditions.

Clinging to surfaces may have to be maintained over long time periods if a stationary position should be retained for applications such as surveillance, inspection or environmental monitoring. Past investigations of the perching action have largely focused on control issues. For example, motion capture camera have been used for off-board control of hovering to land (Frank, McGrew et al. 2007). A similar system has been investigated by others (Cory and Tedrake 2008). Performance of perching maneuvers using morphing airplanes has also been investigated (Wickenheiser and Garcia 2006; Wickenheiser and Garcia 2007; Wickenheiser and Garcia 2008). Other investigations have expanded the basic perching concepts to enable attachment to a vertical wall (Lussier and Cutkosky 2010) or to tree trunks (Kovac, Germann et al. 2009). A typical mechanism includes a system that translates the impact impulse into a snapping movement that sticks small needles into the surface; a small electric motor is used to detach from the wall.

On the other hand, various mechanisms have been proposed for versatile locomotion. These mechanisms employ three major adhesion principles: vacuum suction, magnetic attraction, or gripping with claws (grasping). There are advantages and drawbacks associated with each of these mechanisms. For example, suction requires a smooth surface to meet the sealing requirement, and power efficiency limits the duration of untethered climbing. Magnetic adhesion can be very strong, but is limited to ferromagnetic surfaces. Another mechanism using micro-claws is limited to very rough surfaces such as brick and stone. As an example, U.S. Pat. Application No. 2008/0164080 introduces a micro-claw device for climbing or clinging, which can function only against surfaces of high roughness. U.S. Pat. No. 7,658,347 B2 also introduces a Micro Air-Vehicle (MAV) which provides various functions except for versatile ground locomotion.

In this invention, a simple perching mechanism employing shape-memory alloys is introduced. This perching mechanism can provide unmanned air vehicles (including micro air vehicles) with improved landing and locomotion capabilities.

### SUMMARY OF THE INVENTION

The supplementary drawings help to better understand the invented mechanism, and for explaining the principles of the embodiments. Accompanying drawings are only for the purpose of illustrating the embodiments of the invented mechanism, and should not be considered as a limitation for the invented integrated perching mechanism. In the drawings:

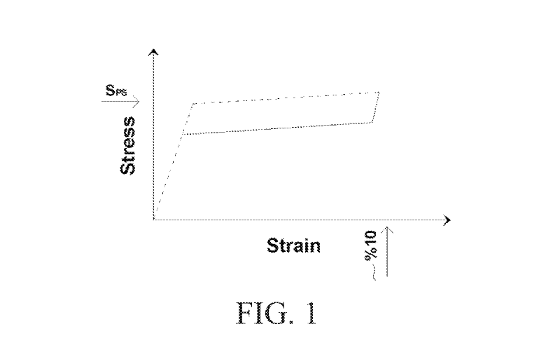

FIG. 1 is a schematic depiction of superelastic force-deformation behavior of shape memory alloys.

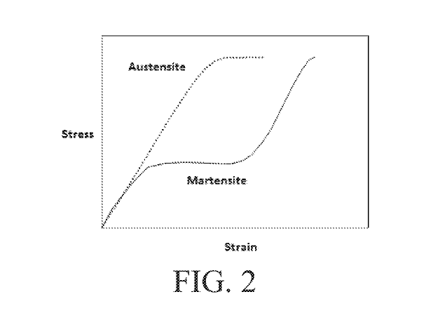

FIG. 2 shows the behavior of the shape memory alloy at different temperature.

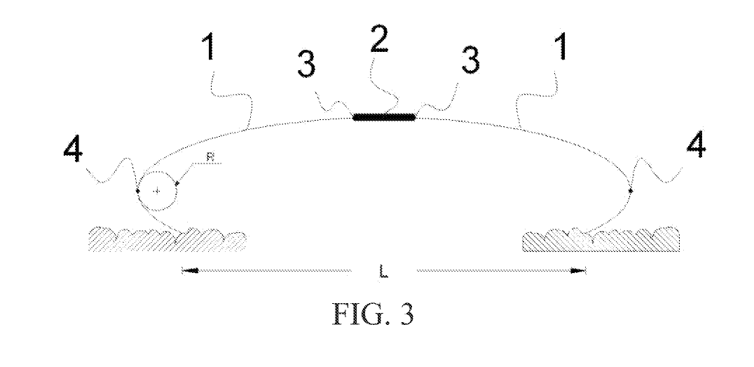

FIG. 3 is an illustration showing 2D view of the shape memory wire toes providing the perching mechanism.

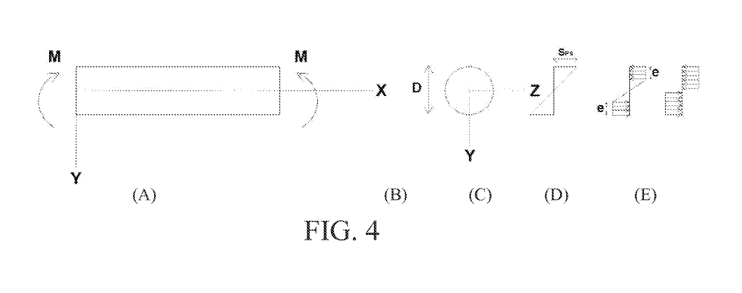

FIG. 4 shows flexural stresses generated in the shape-memory (superelastic) toe at different stages of bending.

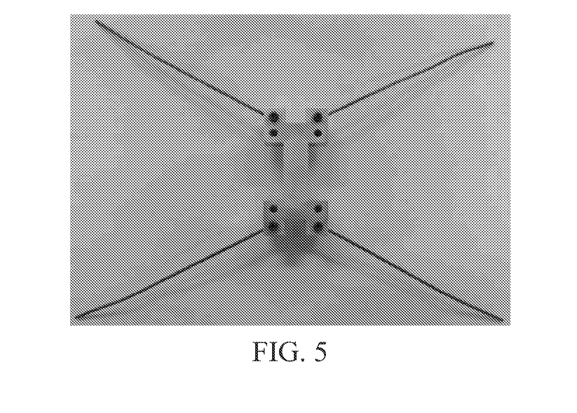

FIG. 5 shows the perching system with four shape memory wire toes before the perching action.

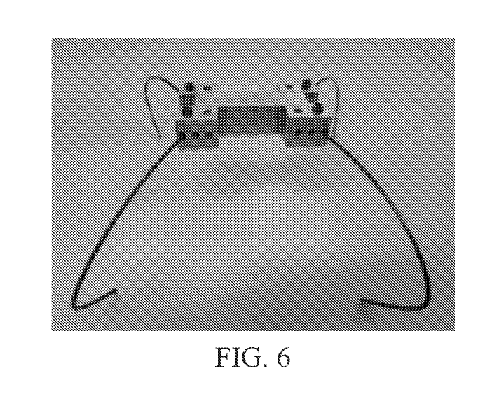

FIG. 6 shows the perching system with four shape memory wire toes after the perching action.

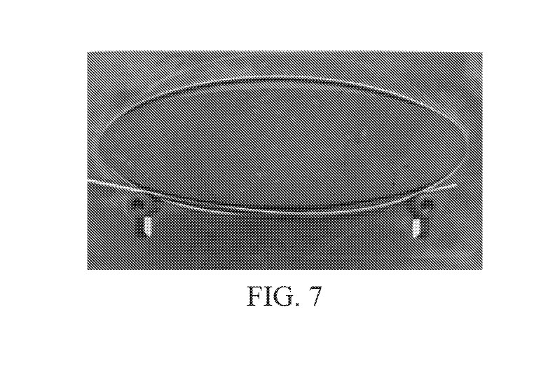

FIG. 7 shows the steel mold used for deforming the shape memory wires into their targeted memory shape for heat treatment

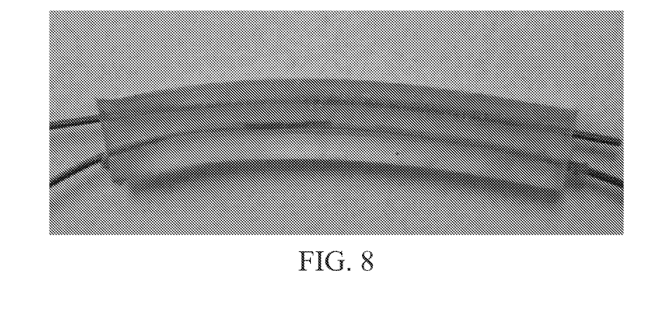

FIG. 8 shows toe made of a composite system comprising shape memory wires and low-modulus rubber for providing two-way perching/recovery action.

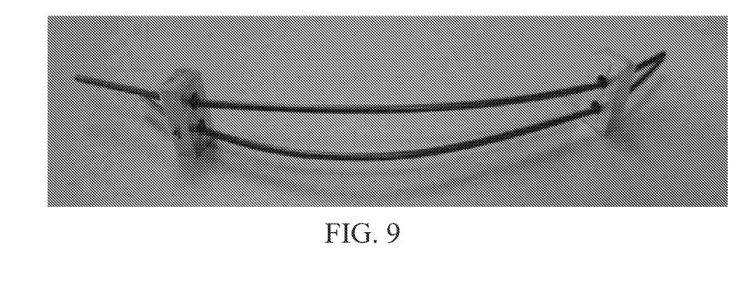

FIG. 9 shows the toe system made of two shape memory wires and fasteners for providing two-way perching/recovering action.

All illustrations presented here are just for depiction of perching mechanism with shape memory alloy toe. The embodiments presented here can be developed with another locomotion system using this perching mechanism on various surfaces.

### DETAILED DESCRIPTION OF PREFERRED EMBODIMENTS OF THE INVENTION

Certain metallic materials will, after an apparent plastic deformation, return to their original shape when heated (see FIG. 1). The same class of materials, in a certain temperature range, can be strained up to approximately 10% and still return to their original shape when unloaded (see FIG. 1). These unusual effects are called shape-memory and superelasticity. Both effects depend upon the occurrence of a specific phase (martensitic) transformation. At temperatures below the transformation temperature, shape memory alloys (SMAs) are martensitic. In this phase, they have a relatively low elastic modulus. Once deformed in low-temperature (martensitic) phase, they recover the original shape and high-modulus austenitic condition upon heating above their transformation temperature. Shape memory alloys exhibit distinctly different stress-strain curves in the martensitic and austenitic phases (see FIG. 2). While the austenitic curve looks like that of a ‘normal’ material, the martensitic one is rather unusual (see FIG. 2). Upon reaching a first yield point, strains of several percent can occur with only little stress increase; thereafter, stress starts to increase again with further deformation. Deformations in the “plateau region” are non-conventional in nature, and can be recovered thermally. Beyond the plateau region, the material would be plastically deformed in a conventional way; such deformations cannot be recovered. The transformation from austenite to martensite, and reverse transformation from martensite to austensite do not take place at the same temperature.

The present invention employs the unique behavior of shape memory materials towards providing bird-like perching action.

The invented perching system employing the shape-memory effect is schematically depicted in FIG. 3. Referring to FIG. 3, the mechanism comprises SMA toes 1 (see FIG. 3) which are attached to the support body 2 (see FIG. 3). The SMA toes 1 (see FIG. 3) are inserted into holes 3 in the support body (see FIG. 3).

In order to provide appropriate perching action, the SMA toes 1 (see FIG. 3) should have a desired curvature. SMA toes 1 (see FIG. 3) memorize their original shape via heat treatment. Once the perching mechanism contacts the surface, heating of toes (which may be accomplished via electrical resistance heating or other heating mechanisms) forces the SMA toes 1 (see FIG. 3) to transform into their memory shape, and provide the perching action.

The curvature of SMA toe in the said mechanism should be designed to provide appropriate perching action. SMA toes should also reach the plateau region of stress-strain curve (see FIG. 1) during perching against the contact surface in order to reliably apply the pressure reached to mobilize frictional forces for adhering to the contact surface. The curvature of SMA toe 1 (see FIG. 3) for the said perching action could be designed as presented below.

The shape memory toe cross-section is subjected to bending at point 4 (see FIG. 3). One can reasonably assume that: (i) plane cross sections of wire remain plane during bending; and (ii) the longitudinal cross-sectional regions in wire are subjected to simple tension or compression during bending, and do not press against one another laterally. The strain (ε) of a cross-sectional region in wire at distance (y) from neutral axis can thus be expressed as follows in terms of the curvature (φ) of the element after bending:

ε=y·φ (1)

Flexural stress distributions at different stages of bending are shown in FIG. 4. The magnitude of the bending moment Mₛₚₛ when the plateaus stress Sₚₛ (see FIG. 4A) is initially reached (see FIG. 4C) can be calculated as follows:

Mₛₚₛ=SₚₛI/c (2)

where, I is the moment of inertia of the cross section with respect to its neutral axis, and c is the distance from the neutral axis to the most remote cross-sectional region of the element. For the case of a circular (wire) toe (see FIG. 4B), the above expression assumes the following form:

$${M}_{sps} = {S}_{ps} \frac{π {D}^{3}}{32} \qquad ( 3 )$$

where, D is the diameter of the circular toe.

At this stage when the plateau stress Sₚₛ is just reached (see FIG. 4C), all cross-sectional regions are still in elastic condition, and the most remote regions have just reached the “plastic” (plateaus stress) condition (which, for a pseudoelastic alloy, is the stress at which the martensite phase of alloy is stress-induced). If bending moment is increased slightly above Mₛₚₛ, stress distribution will be as shown in FIG. 4D. “Plastic” strains penetrate further into the element as the bending moment increases, and eventually all cross-sectional regions reach the “plastic” state (see FIG. 4E). The plastic moment corresponding to this state can be calculated as follows:

$${M}_{p } = \frac{A}{2} \cdot {S}_{ps} \cdot 2 \cdot {C}_{g} \qquad ( 4 )$$

where, A is the cross sectional area and C_{g} is half of the circle gravity center, which is equal to the 4r/(3π).

The moments developed in SMA toes generate the reaction force (R) against the contact surface, which can be expressed as follows:

$$R = \frac{{M}_{p}}{h} . \qquad ( 5 )$$

where, h is the distance between point 4 (see FIG. 3) and the contact point. The friction generated at contact point as a result of the application of force R is the primary effect rendered by the perching action for adherence to rough surfaces.

The unique properties of SMAs noted above have been used to design two-way perching toe systems (see FIG. 8 and FIG. 9) capable of reversible flexural deformations rendering perching and release effects. These systems use the counteracting effects of two shape-memory wires. These wires have been treated to provide 10% recoverable strain in flexure (see FIG. 1). The counteracting effects of the two wires (which renders the two-way effect) are realized by connecting them either mechanically (see FIG. 9) or through embedment in an elastomeric element (see FIG. 8). A mold with the design curvature (see FIG. 7) should be used to heat treat the shape memory wires. A curved memory shape is provided for each wire; the two wires are positioned with their curvatures in opposing directions (see FIG. 8 and FIG. 9). FIG. 8 shows a design where the two shape memory wires are embedded in an elastomeric (e.g., polyurethane) element. The two wires seem to be curved in the same direction in FIG. 8, which is because one of the two wires (which is heated) assumes a higher stiffness upon austenitic phase transformation (see FIG. 2), and forces the other wire to bend in its direction. FIG. 9 shows an alternative design where the two shape memory wires are connected via mechanical links. The bending action is reversed by heating the other wire. Heating of each wire for flexing (perching) and reverse (release) actions is momentary; upon cooling, since the dominating wire is on the upper superelastic plateau (with the other wire on the lower plateau) (See FIG. 2), the deformed shape would be retained until the other wire is heated. This greatly benefits the energy-efficiency of this perching mechanism.

### INVENTION EXAMPLES

### Example 1

Design of the perching system comprising shape memory toes targets development of adequate frictional forces as the shape memory toes press against the surface roughness for resisting the tensile/shear forces generated by the weight of the vehicle, or to perch around the curved surface. The force applied to the surface roughness by shape memory toes is generated by the bending action of toes, and depends upon their “plastic” moment. This force multiplied by the coefficient of friction yields the frictional force which counteracts the separation/shearing effects caused by the weight of the vehicle. The SMA toes considered for production of a first prototype (see FIG. 5 and FIG. 6) was 0.8 mm in diameter; their memory shape comprised an elliptical geometry with 3.2 and 10 cm dimensions (see FIG. 6).

### SMA Toe Curvature Design

FIG. 3 shows the schematics of the SMA toe design. The following parameters are used to design the curvature of the SMA toe 1 (see FIG. 3 and FIG. 4) to provide the perching action:

d (toe diameter)=0.8 mm, Sₚₛ=700 MPa, E=80 GPa, D=1.0 cm (see FIG. 3), h=1 cm (see FIG. 3);

$$( Curvature ) ϕ = \frac{1}{D / 2}$$

ε=y·φ=0.08%

Mₛₚ=0.069 N·m

Mₚ=0.117 N·m

R=11.7 N

The above value of R (11.7 N), assuming a friction coefficient of 0.2, generates 2.34 N frictional resistance normal to the surface. With four toes, this perching mechanism can carry a total force of 9.36 N (954 gram) normal to the contact surface (in upside-down position). The load-carrying capacity of the system would be much higher in climbing position; the exact value depends upon the specifics of system geometry.

### Fabrication of the Shape-Memory Perching System

An elliptical mold (FIG. 7) was used for inducing the memory shape into the SMA toe. The toe is tightened against this mold, and then subjected to the temperature time-history needed for inducing the memory shape. The Ti (55.84 wt. %)-Ni shape-memory alloy, in the form of a wire of 0.8 mm diameter, was molded into the elliptical shape, and subjected to the following temperature time-history: (i) annealing at temperature T for t minutes; (ii) quenching in t₁° C. water, and (iii) aging at 350° C. for t₁ minutes. In order to determine desired levels of processing variables T, t, T₁ and t₁, an optimization experimental program (based on response surface analysis) was implemented, where T was varied in the 500-650° C. range, t in the 15-25 minutes range, T₁ in the 50-90° C. range, and t₁ in the 30-90 minutes range. The preferred values of T, t, T₁ and t₁ were 600° C., 30 minutes, 50° C. and 60 minutes, respectively.

### Development of Perching Systems

FIG. 5 and FIG. 6 show the perching mechanism comprising four SMA toes in straight (before experiencing small heating) and deformed (perched conditions, after experiencing small heating). The weight of each toe in the system is 0.44 gr, and the whole system (including the aluminum body 1 (see FIG. 3) with 3 cm×2 cm outer dimensions) weighs 14.28 gr.

### Example 2

### Two-Way Perching Action (Shape Memory/Elastomer Composite)

The toe 1 (FIG. 3) should be able to recover its original shape after perching to enable release perched state. FIG. 8 shows a design where the two shape memory wires are embedded in an elastomeric (e.g., polyurethane) element. The two wires are placed in elastomer matrix with the curvature opposite direction. The two wires seem to be curved in the same direction in FIG. 8, which is because once one of the two wires is heated it assumes a higher stiffness upon austenitic phase transformation, and forces the other wire to bend in its direction. The two shape memory wires embedded in elastomer (FIG. 9) were heat treated as is described in Example 1 in order to memorize the desired perching shape. Replacing the toe in Example 1 (FIG. 3) with the elastomer matrix composite system could move toe 1 (FIG. 3) capable of the two-way action. At the first step, for the purpose of perching, one shape memory wire is heated to grab the surface (during landing). In the next step, for the purpose of release the original (non-perched) geometry is recovered by heating during separation from surface (to resume flight) the other shape memory wire is heated up to release the toe 1 (FIG. 3) (in application of landing).

Two-Way Perching Action (Shape Memory Wires with Mechanical Links)

FIG. 9 is an alternative design to provide two way perching action where the two shape memory wires are connected via mechanical links. The two wires are heat-treated as described in Example 1 in order to memorize the desired shape. Two mechanical links (See FIG. 9) provided at the two ends of the toe work as rigid connections which force one wire to follow the shape of the other (heated) wire.

For both designs shown in FIG. 8 and FIG. 9, electrical resistance (joule) heating of one wire produces bending of the whole system towards the shape-memory curvature of the heated wire, with the unheated wire flexing in this direction in a superelastic manner.

While the invented mechanism is described in terms of preferred embodiments, they should not be considered as limiting the scope of the invented mechanism. Variations and modifications of the present invention will be used to those skilled in the art, and are intended to be covered in the following appended claims.

What is claimed is:

1. A perching mechanism comprising at least one toe made of at least two groups of shape-memory elements providing bird-like two-way perching action, where;
one group of shape-memory elements realize their shapes upon heating and produce movements opposite to those produced by the other groups of shape-memory elements upon heating:
all shape-memory elements are linked together, and heating of one group of shape memory elements produces deformations which enable perching action for grabbing onto surfaces with at least one of rough and curved conditions, and heating the other groups of shape-memory elements produces opposite deformations which enable release from the surface.

2. The perching mechanism of claim 1 where the shape-memory elements are shape-memory wires.

3. The perching mechanism of claim 1 where the shape-memory elements are made of shape-memory alloys.

4. The perching mechanism of claim 1 where the shape-memory elements are linked via embedment in an elastomer matrix.

5. The perching mechanism of claim 1 where the shape-memory elements are linked via mechanical connection.

6. The perching mechanism of claim 1 where the memory shapes of the shape-memory elements are curved, and the deformations rendering perching and release effects are in the form of bending in opposite directions.

7. The perching mechanism of claim 1 where heating of each group shape memory elements is realized via electrical resistance heating.

8. The perching mechanism of claim 1 where heating of each group of shape memory elements is applied and then discontinued, with the deformations produced by heating each group of shape memory elements retained after cooling said elements.
